(19) United States
(12) Patent Application Publication
(10) Pub. No.: US 2004/0140363 A1
(43) Pub. Date: Jul. 22, 2004

(54) Transfer card with twin slots for memory card

(76) Inventor: Chiu-Kuei Chen, Shinjuang City (TW)

Correspondence Address: RABIN & BERDO, P.C., Suite 500, 1101 14th Street, N.W., Washington, DC, 20005, US

(21) Appl. No.: 10/345,980

(22) Filed: Jan. 17, 2003

(51) Int. Cl. G06K 7/00; G06K 19/06

(52) U.S. Cl. 235/492; 235/486

(57) ABSTRACT

A transfer card with twin slots for memory card includes a card edge of a transfer card at the front end of a frame. The feature of the device is that fixes a U type slot is fixed at the back end of the frame while a memory card connector is embedded in the U type slot. At the right or left side of the frame also sets a slot for arranging a second connector of memory card. Based on the above structure, the transfer card posses two kinds of connectors of memory card at the back and side ends thereof respectively for plugging various specifications of memory cards such as memory cards with CF, MS, SD, MMC, and SM specifications. Thus the device is popular by its applying to various specifications, and is also convenient for users.

### BACKGROUND OF THE INVENTION

1. Field of the Invention

The invention relates to a transfer card with twin slots for memory card, especially to a device fixed a connector of memory card within an U type slot at the back end of a transfer card, and within left or right hand side of the slot of the transfer card fixed a connector of memory card with different specification to adapt various sizes of different memory card specifications (such as memory card with CF, MS, SD, MMC, and SN specification). Thus the device is convenient for consumer's use.

2. Description of the Prior Art

Electronic appliances such as digital cameras, electric dictionaries, personal digital assistants (PDAs) or other electronic appliance are normally use memory cards as storage unit for their portable and transport purposes. Therefore these electronic devices usually provides a slot for inserting of the memory card which stores data transferred from other appliances.

The specifications of memory card of above mentioned electronic devices digital cameras, electric dictionaries, personal digital assistants (PDAs) or other electronic appliance are different from each other. There are several popular memory card specifications, such as CF, MS, SD, MMS, and SM type, etc. in the current market. The data transfer from these different specifications of memory cards to notebook computers or desktop computers for further calculation, modification and storage needs a special transfer card inserted into the device of these computers equipped with PCMICA I/O interface, and then makes data transfer work.

Conventional transfer cards for data transferring only apply to the specific type of memory card either big size (CF) or compact size (for example: MS, SD, MMC, SM etc.). In current market, no all-purpose transfer card device is approachable for various sizes of memory cards. Normally consumer may posses several kinds of memory card by owning different types of electronic appliance that cause problems to plug onto the right PCMCIA interface embedded on various types of computer due to different specification designed. The solution is to buy various types of transfer cards for each appliance specification, this may cause usage annoyance and economic waste.

In order to improve the disadvantage of present transfer cards in the market that could only apply to one or a few specifications type of memory cards, either CF or MS, SD, MMC, SM type, and therefore provides a transfer card with twin slots for memory card.

### SUMMARY OF THE INVENTION

It is therefore a primary object of the present invention to provide a transfer card with twin slots for memory card which could be plugged two different size of memory cards respectively for data transfer so as to resolve consumer's usage annoyance and reduce equipment cost.

In order to attain the above-mentioned purpose, the invention is a kind of transfer card which could insert into interface of note book PC or other kinds of computer. Opposite to the card edge posses a U type slot within which a memory card connector fixed, and at the right (or left) hand side of the frame set a slot within which a second memory card connector fixed opposite to the slot. According to above mentioned structure, memory card connector at the back edge could be plugged by one size of memory card (for example memory card with CF specification, but not to the limitation, memory card with any other type could also fit for this slot), on the other hand, second memory card connector could be plugged by another size of memory card(such as memory card with MS, SD, MMC, but not to the limitation), and therefore makes the transfer card popular in the market of various specification of memory card consumer.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is a sectional view of the present invention;

FIG. 3 is a schematic diagram of the present invention;

FIG. 4 is an embodiment of the present invention with memory card;

FIG. 5 is another embodiment of the present invention with memory card.

### DETAILED DESCRIPTION OF THE PREFERRED EMBODIMENT

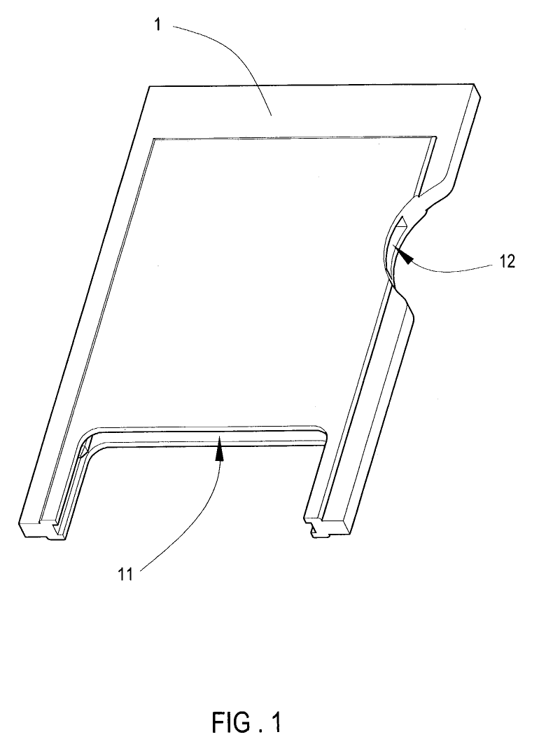

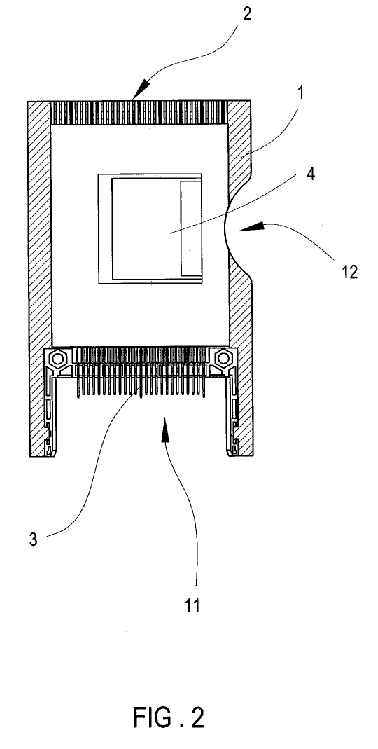

First, please refer to FIG. 1 and FIG. 2, a card edge of a transfer card 2 (68 PIN) in the front end of a frame 1 of the present invention; the characteristics of the present invention are as follows: at the back end of the frame 1 posses a U type slot 11 within which a connector of memory card 3 is fixed and let the connector of memory card 3 be plugged by larger size memory cards such as CF type memory cards 5a, 5b (50 PIN); and at the right or left side of the frame 1 set a slot 12 within which a second connector for memory card 4 is fixed thereof, corresponding to the slot 12, for plugging in smaller size memory cards, such as memory cards 6a, 6b, 6c, and 6d with MS (10 PIN), SD (9 PIN), MMC (7 PIN), and SM (22 PIN) specification respectively.

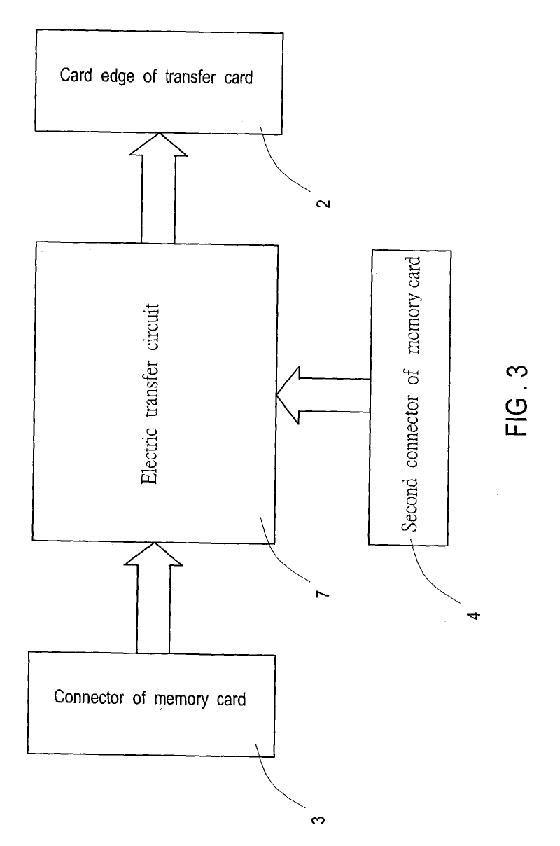

Please also refer to FIG. 3, the card edge of a transfer card 2 is located at the output terminal of an electric transfer circuit 7 of a transfer card while a connector of memory card 3 is disposed at the input terminal of the electric transfer circuit of transfer card 7. And design a set of circuits at the electric transfer circuit of transfer card 7 to connect the connector of memory card 3 with the second connector of memory 4 at the card edge of a transfer card 2 in parallel.

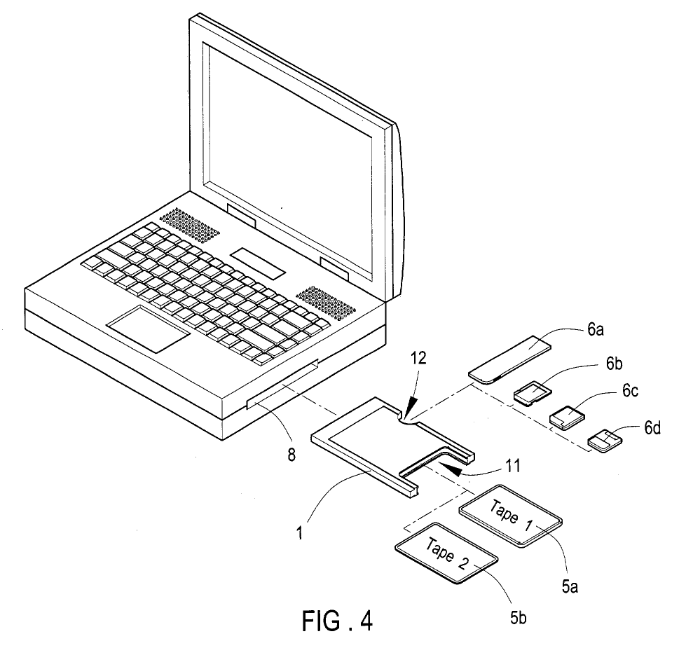

According to above mentioned structure, insert the card edge of the transfer card 2 on the front end of the frame 1 into a connection port 8 of computer interface (as shown in FIG. 4) for plugging larger memory cards (such as memory card 5a, 5b of CF specification) into the U slot 11 of the back end of the frame 1 and communicating with the computer by the transfer card. Under such condition, the difference between CF type memory cards 5a and 5b is only thickness, therefore both are compatible with the U slot 11. On the other hand, smaller size memory cards such as 6a, 6b, 6c, and 6d with MS, SD, MMC, and SM specification respectively having almost the same pin number could be plugged into the slot 12 on the right or left side of the frame 1, and makes memory cards 6a, 6b, 6c and 6d with MS, SD, MMC, and SM specification connect with the second connector for memory card 4, and communicate with computers by the transfer card in order to achieve the purpose of convenient use.

Due to the connector of memory card 3 within the U slot 11 of the frame 1, larger size memory cards 5a, 5b with CF specification can be plugged therein. By the second connector of memory card 4 disposed inside the slot 12 of the frame 1, memory cards 6a, 6b, 6c or 6d with MS, SD, MMC or SM specification can be plugged therein. Therefore the present invention provides and covers transfer function for various sizes of memory cards in the market.

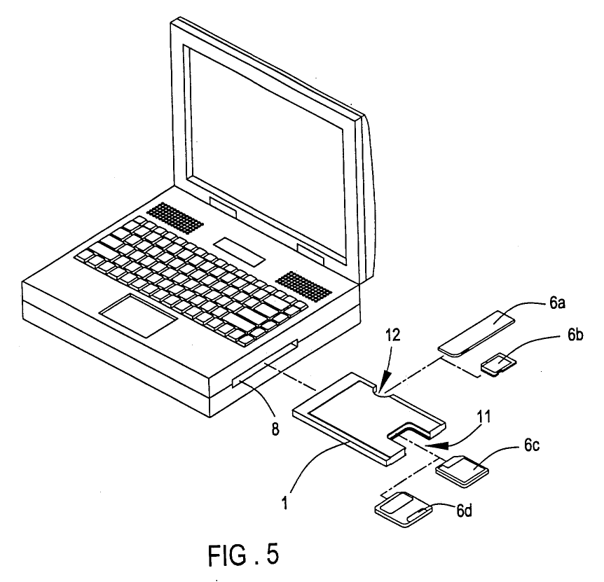

Memory cards 5a, 5b with CF specification have two thickness specification with 3.3 mm and 5.0 mm size respectively. Both of them could be plugged into the connector of memory card 3 within the U type slot 11 of the frame 1 so as to cover the usage of a wide range of specifications and raise the flexibility. Or refer to FIG. 5, the memory card connector 3 is compatible with other specification of memory cards as part of the specifications of MS, SD, MMC, SM, and the second memory card connector 4 at side could be compatible with some other memory card specifications. This is another embodiment of the present invention.

It should be noted that the above description and accompanying drawings are only used to illustrate some embodiments of the present invention, not intended to limit the scope thereof. Any modification of the embodiments should fall within the scope of the present invention.

1. A transfer card with twin slots for memory card comprising
a card edge of a transfer card disposed in the front end of a frame, wherein the invention is characterized in that:
an U type slot is disposed on the rear end of said frame, a connector of memory card for plugging memory cards with certain specifications is installed inside said U type slot; a slot is disposed at the right or left side of said frame with a second connector of memory card is fixed therein for plugging memory cards with other specifications.

2. A transfer card with twin slots for memory card as claimed in claim 1, wherein said card edge of transfer card is located at the output terminal of an electric transfer circuit of the transfer card while said connector of memory card is located at the input terminal of said electric transfer circuit of the transfer card; said electric transfer circuit of the transfer card connects said connector of memory card with said second connector of memory in parallel at the card edge of the transfer card.

3. A transfer card with twin slots for memory card as claimed in claim 1, wherein said connector of memory card on the rear end of said frame is compatible with memory cards with CF specification.

4. A transfer card with twin slots for memory card as claimed in claim 1, wherein said second connector of memory card is compatible with memory cards with CF, MS, SD, MMC, and SM specifications
